(19) United States
(12) Patent Application Publication
(10) Pub. No.: US 2026/0264444 A1
(43) Pub. Date: Sep. 10, 2026

(54) METHOD FOR PRODUCING A SECURITY FEATURE FOR A CARD-SHAPED DATA CARRIER AND CARD-SHAPED DATA CARRIER

(71) Applicant: GIESECKE+DEVRIENT EPAYMENTS GMBH, Munchen (DE)

(72) Inventors: Cristina FABIAN, Garching (DE); Thorsten SAUER, Erding (DE); Klaus KOHL, Miesbach (DE); Thomas TARANTINO, Laufen (DE); Gerhard HAMPP, Munchen (DE)

(21) Appl. No.: 19/153,700

(22) PCT Filed: Feb. 6, 2024
(86) PCT No.: PCT/DE2024/100099

§ 371 Date: Aug. 5, 2025

(30) Foreign Application Priority Data
Feb. 21, 2023 (DE) 10 2023 104 278.5

(51) Int. Cl. B42D 25/47; B42D 25/455

(52) U.S. Cl. CPC B42D 25/47; B42D 25/455

(57) ABSTRACT

A method is for producing a security feature for a data carrier in the form of a card, which has the following steps: providing at least one sheet material and at least one adhesive; bringing the sheet material together with the adhesive to form a mixture; disintegrating the mixture to form a multiplicity of scraps; applying at least one layer of the multiplicity of scraps on a lamination plate; laminating the layer in order to form at least one foil as a security feature for the data carrier in the form of a card, the foil having an overlapping inhomogeneous distribution of the scraps. A data carrier is in the form of a card having such a security feature.

The invention relates to a method for producing a security feature for a data carrier in the form of a card and to a data carrier in the form of a card, in particular a chip card or a smartcard or an identification card, having a security feature.

Many data carriers in the form of cards are known from the prior art, for example smartcards, chip cards, in particular with RFID (radiofrequency identification) technology, integrated-circuit cards, dual-interface cards or identification cards. In particular, the use of smartcards, for example credit cards or payment cards, has become established for carrying out financial transactions. Data carriers in the form of cards, such as documents of value, for example passport or identity documents, identity cards and the like, are being used to an increasing extent in public sectors, as well as in the company in-house sector.

Optical security elements on the data carriers in the form of cards are known, and are generally intended to increase the security against counterfeiting. In view of the decreasing cost and the consequently increasing availability of advanced reproducing equipment, there is a risk that counterfeit reproductions of data carriers in the form of cards will be made. Depending on the level of expertise of criminals, some reproductions might not only fool the general public who use the data carriers in the form of cards, but also validation machines and card readers that are employed to authenticate users and to authenticate transactions.

It is an object of the present invention to improve the production of security features for data carriers in the form of cards, in order to prevent illegal reproduction and at the same time to provide a visually appealing design.

This object is achieved by methods for producing a security feature for a data carrier in the form of a card and by a data carrier in the form of a card according to the independent patent claims. Embodiments and developments of the invention are specified in the dependent claims.

Features and details that are described in connection with the method according to the invention for producing a security feature for a data carrier in the form of a card also apply in connection with the data carrier in the form of a card according to the invention, and vice versa, so that in respect of the disclosure reference may always be made to each of the individual aspects of the invention.

In the context of the application, the invention may preferentially be employed for smartcards, in particular for credit cards and payment cards. They may, however, also be used for other identification cards, in particular identity cards or passports, or RFID devices, for example key cards, access cards, tokens, wearables or security passes.

In the context of the application, different methods are presented, a feature common to all of which is that they provide improved production methods for security features for data carriers in the form of cards. In particular, the methods present different ways of achieving the object of the present invention.

According to one aspect of the invention, a method for producing a security feature for a data carrier in the form of a card is provided, which has the following steps:
providing at least one sheet material and at least one adhesive;
bringing the sheet material together with the adhesive to form a mixture;
disintegrating the mixture to form a multiplicity of scraps;
applying at least one layer of the multiplicity of scraps on a lamination plate;
laminating the layer in order to form at least one foil as a security feature for the data carrier in the form of a card, the foil having an overlapping inhomogeneous distribution of the scraps.
The order of the steps of the methods according to the invention that are disclosed in the context of the application is not necessarily restricted to the order described or chronologically fixed.

In the context of the application, the sheet material is formed for example by papers of value such as banknotes, checks, credit vouchers, etc. Banknotes may preferentially be employed. For the sheet material, materials such as for example paper or cotton may preferentially be provided. Furthermore, in the context of the application, the adhesive may fulfill the function of a binder so that the adhesive can preferentially bond permanently with the sheet material. In other words, the adhesive can preferentially adhere permanently to the sheet material and form a mixture. Bringing the sheet material together with the adhesive provides the mixture, or a compound between the sheet material and the adhesive.

Furthermore, in the context of the application a multiplicity of scraps may be formed from the mixture. Preferentially, the mixture may for this purpose be disintegrated, in particular shredded or cut up or comminuted in another way. The scraps comprise in particular comminuted parts of the mixture, i.e. comminuted parts that each consist partially of adhesive and sheet material.

A layer of the scraps is preferentially applied, or arranged, on a lamination plate. This layer may preferentially have the dimensions of the foil of the data carrier in the form of a card to be produced, for example in the ID-1 format or the ISO standards. In particular, the layer is laminated to form a foil. This foil may preferentially be combined with other foils to form a foil laminate, and the data carrier in the form of a card may be formed therefrom. It is to be understood that electronic components, for example a chip module or an antenna, and corresponding module openings may be applied to the data carrier in the form of a card in further subsequent method steps.

Alternatively, the layer may be formed as a multiple-use sheet from which individual foils for a plurality of data carriers in the form of cards may be separated in a subsequent method step following the lamination.

Furthermore, in the context of the application, the multiplicity of scraps are distributed overlapping and inhomogeneously in or on the foil. The term overlapping may in this case describe the fact that the scraps are arranged partially overlapping with one another. The term inhomogeneously may in this case describe the fact that the scraps are distributed or arranged randomly, in particular without a defined or desired pattern.

In the context of the application, in particular, a foil is formed as a security feature for the data carrier in the form of a card. Since the foil comprises the scraps, the advantage may be achieved that the scraps cannot be reproduced by taking a photocopy of the data carrier in the form of a card or by scanning and printing, even if the copy or the print is of the highest quality. Consequently, illegal reproduction of the data carrier in the form of a card can be prevented and the authenticity of the data carrier in the form of a card can be guaranteed by means of the security feature.

The invention therefore has the advantage that the disintegrated sheet material, for example shredded banknotes, already constitutes a security feature for a data carrier in the form of a card, and a specific and individual design of the data carrier in the form of a card may likewise be produced. Since the distribution of the scraps is random for each foil produced, large-scale counterfeiting is prevented. In particular when using banknotes, the banknotes themselves already have different security features, which are then implemented in the foil of the data carrier in the form of a card and additionally increase the protection against counterfeiting. A new security feature for data carriers in the form of cards may therefore be provided easily and economically. Furthermore, old banknotes or sheet material that can no longer be used may therefore preferentially be recycled and reused, which can be beneficial to the environment.

Alternatively, freshly produced banknotes that have a desired design may also be employed. In particular, the design possibilities of the data carrier in the form of a card may be extended significantly by the use of banknotes from foreign countries.

In one particularly preferred embodiment, the adhesive may be formed as a varnish, in particular as a screen printing varnish, or as an adhesive foil, in particular as an opaque or transparent PVC foil. Forming the adhesive as a varnish has the advantage that the adhesive can be brought together particularly easily with the sheet material, or bonded easily. In particular, the screen printing varnish may easily be applied onto the sheet material, in particular onto a sheet of banknotes that has not yet been disintegrated. Forming the adhesive as an adhesive foil has the advantage that, for example, the banknote may be applied onto the adhesive foil and may be shredded together. A composite between the adhesive and the banknote may therefore easily be produced. An opaque PVC adhesive foil, which may have a thickness of 80 μm, may preferentially be employed in this case. In general, the advantage may be achieved that a foil with good haptics of the scraps can be produced.

According to a second aspect of the invention, a further method for producing a security feature for a data carrier in the form of a card is provided, which has the following steps:
providing at least one carrier, at least one adhesive and at least one sheet material;
applying the adhesive onto the carrier;
disintegrating the sheet material to form a multiplicity of scraps;
applying the multiplicity of scraps onto the adhesive of the carrier;
removing the carrier from the adhesive in order to form at least one foil as a security feature for the data carrier in the form of a card, the foil having an overlapping inhomogeneous distribution of the scraps.

In particular, the adhesive may be applied at least partially, preferentially surface-wide onto the carrier. In contrast to the method described above, in this case the sheet material is disintegrated, in particular shredded or cut up or comminuted in another way, without the adhesive. By way of example, a multiplicity of banknotes may be shredded to form a multiplicity of scraps. The scraps therefore comprise in particular comminuted parts of the sheet material. The scraps are subsequently applied onto the adhesive. In this way, the scraps can adhere permanently to the adhesive. Individual or excess scraps which do not exhibit sufficient adhesion to the adhesive may preferentially be removed, for example by shaking or vibration. Once the adhesion of the scraps to the adhesive has been achieved, the carrier may be removed from the adhesive again. For example, the carrier may be peeled off from the adhesive. In other words, the adhesive is arranged only temporarily on the carrier.

In one particularly preferred embodiment, the application of the multiplicity of scraps onto the adhesive may take place by means of a dip bath or a scattering process. For example, the scraps may be scattered onto the adhesive. This may be done mechanically or manually. It has the advantage that the scraps can be bonded with the adhesive, and the inhomogeneous distribution of the scraps is produced, particularly easily. Alternatively, the scraps may be applied by means of a dip bath onto the adhesive. For example, the adhesive on the carrier may be dipped into a tank manually or by means of a frame, wherein the scraps are arranged in the tank. The scraps can therefore come into contact with the adhesive and remain adhering thereto. This likewise produces the inhomogeneous distribution of the scraps. Alternatively or in addition, it is possible for a process of ironing the scraps on the adhesive to take place in order to achieve a homogeneous surface distribution of the scraps on the adhesive. This can reinforce the adhesion of the scraps to the adhesive.

Preferably, the carrier may be formed as a foil layer, in particular as a PVC foil layer, or as a silicone carrier. The carrier may be formed particularly easily and economically as a PVC foil layer or as a silicone carrier. In particular, the carrier is flatly configured and preferentially has the dimensions of the foil to be produced. For example, the carrier may have dimensions in the ID-1 format or the ISO standards.

In a further preferred embodiment, the adhesive may be formed as a varnish, in particular as a screen printing varnish. For example, a varnish may be applied as adhesive on a silicone carrier. This is preferentially suitable for the use of a dip bath for applying the scraps on the varnish. For example, the dip bath may be followed by drying, in particular UV curing, after which the silicone carrier may be peeled off, or removed, from the adhesive with the scraps. A screen printing varnish or a screen printing adhesive may preferentially be used when a PVC foil layer is employed as the carrier.

According to a third aspect of the invention, a further method for producing a security feature for a data carrier in the form of a card is provided, which has the following steps:
providing at least one foil material and at least one sheet material:
disintegrating the sheet material to form a multiplicity of scraps;
introducing the foil material and the multiplicity of scraps as a mixture into an extruder of an extrusion device;
heating the mixture to form a melt;
extruding the melt (20) through a nozzle exit slit of the extrusion device in order to form at least one foil as a security feature for the data carrier in the form of a card, the foil having an overlapping inhomogeneous distribution of the scraps.

In other words, the scraps are employed in an extrusion method.

In the context of the application, the foil material may for example be provided as granules for the extruder, in particular as plastic granules. In the extruder, the mixture of the foil material and the multiplicity of scraps may be heated to form a melt, or melted. In other words, the mixture is converted into a molten state. In particular, the melt comprises the molten foil material and the scraps. For this purpose, the sheet material and therefore also the scraps are preferably formed so as to be thermally stable. The melt may subsequently be extruded, or pressed, through the nozzle exit slit. By the extrusion of the melt through the nozzle exit slit, a foil may be formed. The nozzle exit slit in this case constitutes a shaping opening. In particular, scraps that are integrated in the foil by the extrusion constitute a security feature overall. The extruded melt may conventionally be cooled, or fully solidified, in a particular time interval after emerging from the nozzle exit slit. By the solidification of the foil, the foil can form a kind of solid matrix around the scraps, so that they are fixed. Consequently, the security feature of the scraps can be integrated permanently into the foil. For the cooling, the extruded melt may for example be delivered to a roll arrangement, which comprises at least one cooling roll, adjacent to the nozzle exit slit. For example, for this purpose the scraps may preferentially have a size of at most 100 μm. Employing extrusion for producing the foil with the scraps has, in particular, the advantage that a foil ready for use may be produced, which can be further processed directly to make the data carrier in the form of a card.

Alternatively, it is likewise conceivable for an injection molding method to be used. For this purpose, at least one foil material and at least one sheet material may be provided. The foil material may preferentially be provided as granules. The sheet material is preferentially disintegrated, for example shredded, to form a multiplicity of scraps. The foil material and the multiplicity of scraps may subsequently be introduced as a mixture into an injection molding unit. The injection molding unit has a rotatable worm, or a worm shaft, inside a cylinder. Provided in the region of the cylinder, there is preferentially a hopper or filler via which the cylinder can be filled with the mixture. The worm rotating in the cylinder can deliver the filled mixture in the direction of an injector, or a nozzle. Through the nozzle, the filled mixture can be pressed into a desired shape, particularly into the foil shape to be produced. For this purpose, the mixture is preferentially heated so that the foil material can melt and therefore can be pressed more easily into shape. In particular, the scraps are for this purpose formed so as to be thermally stable.

By means of the pressing into the foil shape, a foil as a security feature for the data carrier in the form of a card may be formed, the foil having an overlapping inhomogeneous distribution of the scraps. The described injection molding method is preferentially suitable for data carriers in the form of cards to be produced without inlays, the foil that is formed being for example laminated with further foils and a chip module being arranged in a module opening.

According to a fourth aspect of the invention, a further method for producing a security feature for a data carrier in the form of a card is provided, which has the following steps:
providing at least one sheet material and at least one adhesive;
disintegrating the sheet material to form a multiplicity of scraps;
bringing, in particular compressing, the multiplicity of scraps together with the adhesive to form at least one briquette;
separating at least one layer from the briquette in order to form at least one foil as a security feature for the data carrier in the form of a card, the foil having an overlapping inhomogeneous distribution of the scraps.

In contrast to the method described above, in this case the sheet material is disintegrated, in particular shredded or cut up or comminuted in another way, without the adhesive. By way of example, a multiplicity of banknotes may be shredded to form a multiplicity of scraps. The scraps therefore comprise in particular comminuted parts of the sheet material. Preferentially, the adhesive is pressed with the multiplicity of scraps to form at least one briquette. In this way, good adhesion may be achieved between the adhesive and the scraps. The pressed briquette may preferentially have the length and width dimensions of the foil of the data carrier in the form of a card to be produced, for example in the ID-1 format or the ISO standards.

The separation of the layer or layers from the briquette may preferentially take place by cutting. The separated layer respectively forms the foil with the security feature. These foils may then be processed further, in particular laminated, for the production of data carriers in the form of cards.

In one particularly preferred embodiment, the separation of the layer may take place by cutting out the layer with a thickness of at least 100 μm and at most 850 μm, preferentially 200 μm. The thickness of the layers to be separated may be adapted variably to the desired foil thickness.

Preferably, the multiplicity of scraps may have a rectangular and/or strip-like and/or circular shape. In general, scraps may be produced in an arbitrary geometrical shape. In particular, a mixture of different geometrical shapes, for example strip-shaped and circular scraps, may also be employed for the multiplicity of scraps. The scraps are preferentially formed as confetti. By means of a circular shape of the scraps, a uniform surface distribution of the scraps may be achieved. In other words, the scraps in particular do not protrude beyond the surface of the foil.

Advantageously, the sheet material may be formed by a banknote, cellulose, paper or a polymer banknote. Likewise, materials consisting of biaxially oriented polypropylene may also be envisioned. Alternatively, hybrid banknotes which comprise both a polymer and paper, or polymer banknotes which consist only of at least one polymer, may also be employed.

Alternatively or in addition, at least one overlay foil may be arranged on a surface of the foil. The overlay foil may for example be arranged on the surface of the foil, and laminated and bonded therewith, after the production of the foil. In particular, a preferentially transparent overlay foil may be arranged on a surface of the foil. The foil with the scraps is therefore visually clearly recognizable, although the scraps are protected against external influences because of the overlay foil. In addition, a further overlay foil may be arranged on an opposite surface so that the foil with the scraps is arranged sandwiched between the overlay foils. The further overlay foil may be formed so as to be opaque or transparent. Alternatively, the foil with the scraps may be arranged externally on the data carrier in the form of a card. The user may therefore, in particular, feel the haptics of the scraps.

In one preferred embodiment, at least one inlay may be separated, in particular stamped or cut or lasered, from the foil. By means of an inlay, a window may for example be formed inside a further foil. Arbitrary geometrical shapes or sheet materials and adhesive materials may in this case be used for the inlay. The inlay has the overlapping inhomogeneous distribution of the scraps and may therefore be employed just like the foil as a security feature for a data carrier in the form of a card. For example, the stamped inlay with the scraps may be introduced into a corresponding recess of a further foil and laminated together.

Advantageously, the distribution of the scraps may be formed at least partially, in particular surface-wide on the foil. Preferentially, the distribution of the scraps is formed surface-wide on the foil, i.e. in other words without gaps. It is, however, likewise conceivable for the distribution of the scraps to be locally limited in a subregion of the foil.

According to a fifth aspect of the invention, a data carrier in the form of a card, in particular a smartcard is provided, having a card body on which or in which a security feature is arranged, the security feature being produced by a method according to one of the preceding embodiments. The same advantages and modifications as described above apply.

Alternatively, it is likewise conceivable for the scraps to have a strip-like geometrical shape and to be able to have an overlapping homogeneous distribution instead of an overlapping inhomogeneous distribution. The scraps are preferentially formed identically, in particular with the same geometrical dimensions. As an example, identical elongate strips may be cut out from a banknote as sheet material. This method is preferentially suitable for employing a carrier on which an adhesive is applied. For example, the scraps may be arranged in a predetermined distribution on the adhesive. It is possible for the scraps to be arranged in a network, individual scraps being arranged overlapping with one another. This distribution may be provided in the manner of a textile, and therefore homogeneously. The scraps may adhere to the adhesive in the homogeneous distribution and the carrier may be removed from the adhesive in order to form at least one foil as a security feature. Preferentially, overlay foils are in this case provided for the foil.

The present invention is described below with reference to the appended figures by way of example in the context of embodiments. Individual features of the embodiments may of course be freely combined with one another, insofar as is technically feasible, without departing from the scope of the present invention. Elements with the same function and effect are provided with the same reference signs in the figures. In the figures, schematically:

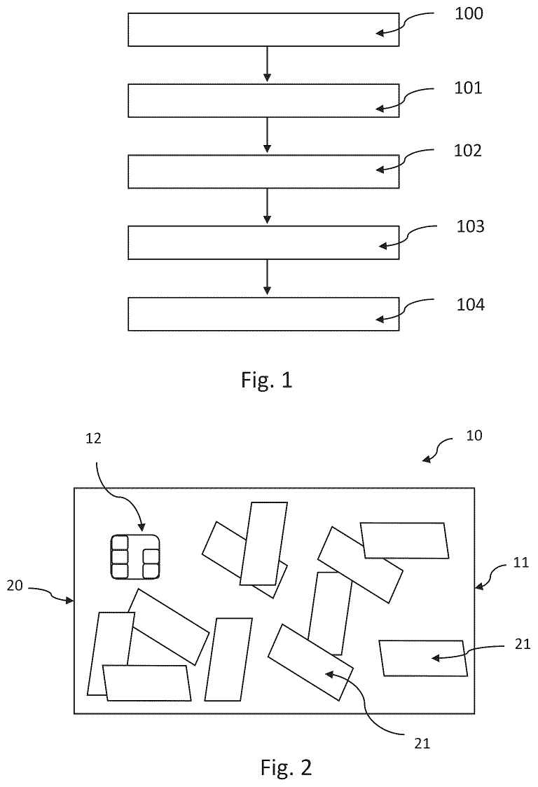

FIG. 1: shows a schematic view of a method for producing a security feature for a data carrier in the form of a card;

FIG. 2: shows an outline representation of a data carrier in the form of a card with a security feature;

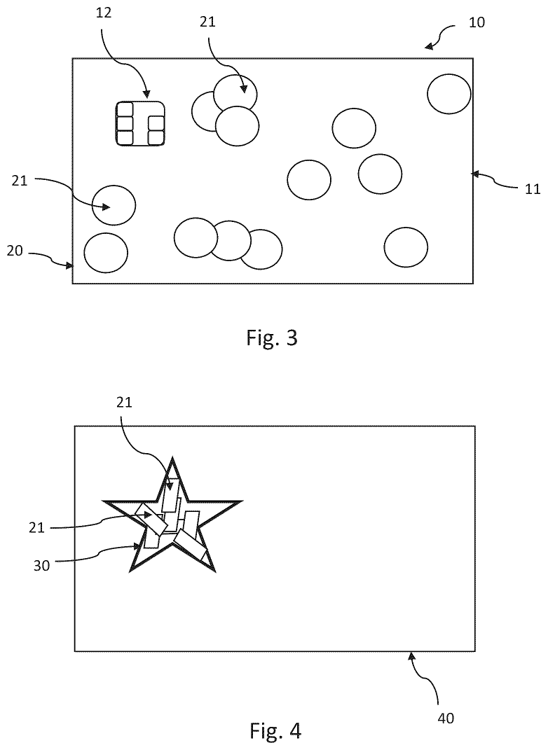

FIG. 3: shows a further outline representation of a data carrier in the form of a card with a security feature; and

FIG. 4 shows a schematic view of a foil layer with an inlay as a security feature.

FIG. 1 shows a schematic view of a method for producing a security feature for a data carrier in the form of a card. The method comprises by way of example the following steps. First, a sheet material and an adhesive are provided 100. By way of example, the sheet material is formed as a multiplicity of banknotes. The adhesive is formed by way of example as a screen printing varnish or as an adhesive foil.

Subsequently, the sheet material is brought together 101 with the adhesive to form a mixture. In other words, the banknotes are bonded with the screen printing varnish or the adhesive foil to form a mixture. Expressed another way, the banknotes and the screen printing varnish or the adhesive foil adhere to one another. Subsequently, the mixture is disintegrated 102 to form a multiplicity of scraps. The disintegration takes place by way of example by shredding the mixture. The scraps therefore comprise in particular comminuted parts of the mixture. Subsequently, a layer of the multiplicity of scraps is applied 103 on a lamination plate. This layer may preferentially have the dimensions of the foil of the data carrier in the form of a card to be produced, for example in the ID-1 format or the ISO standards. Subsequently, the layer is laminated 104 to form a sheet as a security feature for the data carrier in the form of a card. The foil has an overlapping inhomogeneous distribution of the scraps. In other words, the foil that is formed comprises the comminuted parts of the mixture of the banknotes and the adhesive. In particular since the inhomogeneous and random distribution of the scraps on the foil is unique for each foil produced, illegal counterfeiting can be counteracted. The foil with the scraps that is formed therefore constitutes a security feature.

The foil that is formed may preferentially be combined with further foils, for example overlay foils, to form a foil laminate and formed into the data carrier in the form of a card by means of lamination. It is to be understood that electronic components, for example a chip module or an antenna, and corresponding module openings may be applied to the data carrier in the form of a card in further subsequent method steps.

FIG. 2 shows an outline representation of a data carrier 10 in the form of a card with a foil 20 as a security feature. The data carrier 10 in the form of a card is formed by way of example as a smartcard. The data carrier 10 in the form of a card has a rectangular card body 11, which comprises a foil 20. The foil 20 constitutes a security feature and is produced by way of example with the method according to FIG. 1.

The foil 20 therefore has an overlapping inhomogeneous distribution of scraps 21. For illustrative purposes, the scraps 21 are represented on an enlarged scale in the figure. Expressed another way, the scraps 21 have a random distribution in the foil 20. There is by way of example no predetermined pattern or specific order for the distribution of the scraps 21. The scraps 21 are by way of example strip-shaped and are arranged partially overlapping with one another.

Furthermore, a chip module 12 for contact-based communication of the data carrier 10 in the form of a card with a card reader is provided on the card body 11. The chip module 12 is arranged in a corresponding module opening of the card body 11. Further electronic components may be provided, for example an antenna for contactless communication.

FIG. 3 shows a further outline representation of a data carrier 10 in the form of a card with a security feature. The data carrier 10 in the form of a card is formed in a similar way to FIG. 2. In contrast to FIG. 2, the scraps 21 are formed as confetti. In other words, the scraps 21 in FIG. 3 each have a circular shape.

FIG. 4 shows a schematic view of a foil layer 40 with an inlay 30 as a security feature. By way of example, a foil may initially be produced by the method according to FIG. 1. The inlay 30 may then be stamped or cut out from this foil 20. The inlay 30 consequently also has the overlapping inhomogeneous distribution of the scraps 21. By way of example, the inlay 30 is star-shaped. Nevertheless, arbitrarily varying geometrical shapes may be provided for the inlay 30.

The inlay 30 is arranged by way of example in a corresponding recess of the foil layer 40. Such an inlay 30 may, for example, be used to produce a window in the foil layer 40.

### LIST OF REFERENCE SIGNS

10 data carrier in the form of a card
11 card body
12 chip module
20 foil
21 scrap
30 inlay
40 foil layer
100 first method step
101 second method step
102 third method step
103 fourth method step
104 fifth method step

1-15. (canceled)

16. A method for producing a security feature for a data carrier in the form of a card, which has the following steps:
providing at least one sheet material and at least one adhesive;
bringing the sheet material together with the adhesive to form a mixture;
disintegrating the mixture to form a multiplicity of scraps;
applying at least one layer of the multiplicity of scraps on a lamination plate;
laminating the layer in order to form at least one foil as a security feature for the data carrier in the form of a card, the foil having an overlapping inhomogeneous distribution of the scraps.

17. The method according to claim 16, wherein the adhesive is formed as a varnish.

18. A method for producing a security feature for a data carrier in the form of a card, which has the following steps:
providing at least one carrier, at least one adhesive and at least one sheet material;
applying the adhesive onto the carrier;
disintegrating the sheet material to form a multiplicity of scraps;
applying the multiplicity of scraps onto the adhesive of the carrier;
removing the carrier from the adhesive in order to form at least one foil as a security feature for the data carrier in the form of a card, the foil having an overlapping inhomogeneous distribution of the scraps.

19. The method according to claim 18, wherein the application of the multiplicity of scraps onto the adhesive takes place by means of a dip bath or a scattering process.

20. The method according to claim 18, wherein the carrier is formed as a foil layer.

21. The method according to claim 18, wherein the adhesive is formed as a varnish.

22. A method for producing a security feature for a data carrier in the form of a card, which has the following steps:
providing at least one foil material and at least one sheet material:
disintegrating the sheet material to form a multiplicity of scraps;
introducing the foil material and the multiplicity of scraps as a mixture into an extruder of an extrusion device;
heating the mixture to form a melt;
extruding the melt through a nozzle exit slit of the extrusion device in order to form at least one foil as a security feature for the data carrier in the form of a card, the foil having an overlapping inhomogeneous distribution of the scraps.

23. A method for producing a security feature for a data carrier in the form of a card, which has the following steps:
providing at least one sheet material and at least one adhesive;
disintegrating the sheet material to form a multiplicity of scraps;
bringing the multiplicity of scraps together with the adhesive to form at least one briquette;
separating at least one layer from the briquette in order to form at least one foil as a security feature for the data carrier in the form of a card, the foil having an overlapping inhomogeneous distribution of the scraps.

24. The method according to claim 23, wherein the separation of the layer takes place by cutting out the layer with a thickness of at least 100 μm and at most 850 μm.

25. The method according to claim 16, wherein the multiplicity of scraps have a rectangular and/or strip-like and/or circular shape.

26. The method according to claim 16, wherein the sheet material is formed by a banknote, cellulose, paper or a polymer banknote.

27. The method according to claim 16, wherein at least one overlay foil is arranged on a surface of the foil.

28. The method according to claim 16, wherein at least one inlay is separated from the foil.

29. The method according to claim 16, wherein the distribution of the scraps is formed at least partially on the foil.

30. A data carrier in the form of a card, having a card body on which or in which a security feature is arranged, the security feature being produced by a method according to claim 16.
